(19) United States
(12) Patent Application Publication
(10) Pub. No.: US 2006/0098919 A1
(43) Pub. Date: May 11, 2006

(54) MOUNTING STRUCTURE FOR OPTICAL SUBASSEMBLY

(76) Inventor: Phillip J. Edwards, San Jose, CA (US)

Correspondence Address: ROBERT A. PARSONS, 4000 N. CENTRAL AVENUE, SUITE 1220, PHOENIX, AZ, 85012, US

(21) Appl. No.: 10/790,163

(22) Filed: Mar. 1, 2004

Related U.S. Application Data
(60) Provisional application No. 60/452,686, filed on Mar. 7, 2003.

(51) Int. Cl. G02B 6/42

(52) U.S. Cl. 385/52

(57) ABSTRACT

A mounting structure is disclosed for mounting optical devices in optical alignment with optical systems. A mounting comb includes a base and a plurality of spaced apart fingers extending from the base perpendicular to and opposite a mounting surface. The mounting surface of the mounting comb is fixedly attached to the surface of a substrate with the fingers extending outwardly from the substrate. A receiving comb includes a base with a mounting surface and a plurality of spaced apart fingers extending from the base perpendicular to and opposite the mounting surface. The optoelectronic device is fixedly mounted on the mounting surface of the receiving comb. The fingers of the receiving comb and the mounting comb are fixed in an interdigitated orientation by a layer of adhesive so that an I/O light port of the optoelectronic device is optically aligned with an I/O light port of the optical system.

### CROSS-REFERENCE TO RELATED APPLICATIONS

This application claims the benefit of U.S. Provisional Application No. 60/452,686, filed 7 Mar. 2003.

### FIELD OF THE INVENTION

This invention relates to optoelectronic packaging and, more particularly, to optical component mounting structures.

### BACKGROUND OF THE INVENTION

In optical-to-electrical and electrical-to-optical (hereinafter “optoelectric”) modules used in the various communications fields, one of the most difficult problems that must be solved is the stable alignment and positioning of the various components. Generally, there are two types of lasers that are used in optoelectric modules, edge emitting lasers and surface emitting lasers. Edge emitting lasers emit light in a path parallel to the mounting surface while surface emitting lasers emit light perpendicular to the mounting surface. The light from either of the lasers must then be directed into an optical fiber for transmission to a remotely located light receiver (i.e., a photodiode or the like).

Lens systems are generally used at both ends of the optical fiber to direct light from a light-generating component into the optical fiber and to direct light from the optical fiber onto a light-sensing component. The apparatus used to mount the optical components and the lens systems can have a substantial effect on the construction of the optical systems and the assembly procedures for the optical systems. Also, the mounting structure for the optical components and the lens system must be very rugged and stable so that optical alignment is not disturbed by use or temperature changes. Further, it is desirable to be able to compensate for variations in laser thickness which can substantially impact optical alignment.

It would be highly advantageous, therefore, to remedy the foregoing and other deficiencies inherent in the prior art.

It is an object of the present invention to provide a new and improved mounting structure for optical components or subassemblies in optoelectronic modules.

Another object of the present invention is to provide a new and improved optical component mounting structure that can be easily incorporated into any of the present optoelectric modules.

Another object of the present invention is to provide a new and improved optical component mounting structure that provides greater flexibility in the mounting of components and less sensitivity to temperature variations.

Another object of the present invention is to provide a new and improved optical component mounting structure that provides greater reliability and optical alignment throughout temperature variations.

Another object of the present invention is to provide a new and improved optical component mounting structure that is rugged and stable so that optical alignment is not disturbed by use or temperature changes.

### SUMMARY OF THE INVENTION

Briefly, to achieve the desired objects of the instant invention in accordance with a preferred embodiment thereof, a mounting structure is disclosed for mounting optical devices in optical alignment with optical systems. The mounting structure includes a mounting comb with a base and a plurality of spaced apart fingers extending from the base perpendicular to and opposite a mounting surface. The mounting surface of the mounting comb is fixedly attached to the surface of a substrate with the fingers extending outwardly from the substrate. The mounting structure further includes a receiving comb with a base and a plurality of spaced apart fingers extending from the base perpendicular to and opposite a mounting surface. The optoelectronic device is fixedly mounted on the mounting surface of the receiving comb. The fingers of the receiving comb and the mounting comb are fixed in an interdigitated orientation by a layer of adhesive so that an I/O light port of the optoelectronic device is optically aligned with an I/O light port of the optical system.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is an exploded plan view of a mounting structure with rectangular fingers in accordance with the present invention;

FIG. 2 is an assembled plan view of the mounting structure illustrated in FIG. 1 with rectangular fingers; and

FIG. 3 is an assembled plan view of another embodiment of a mounting structure with triangular fingers.

### DETAILED DESCRIPTION OF THE DRAWINGS

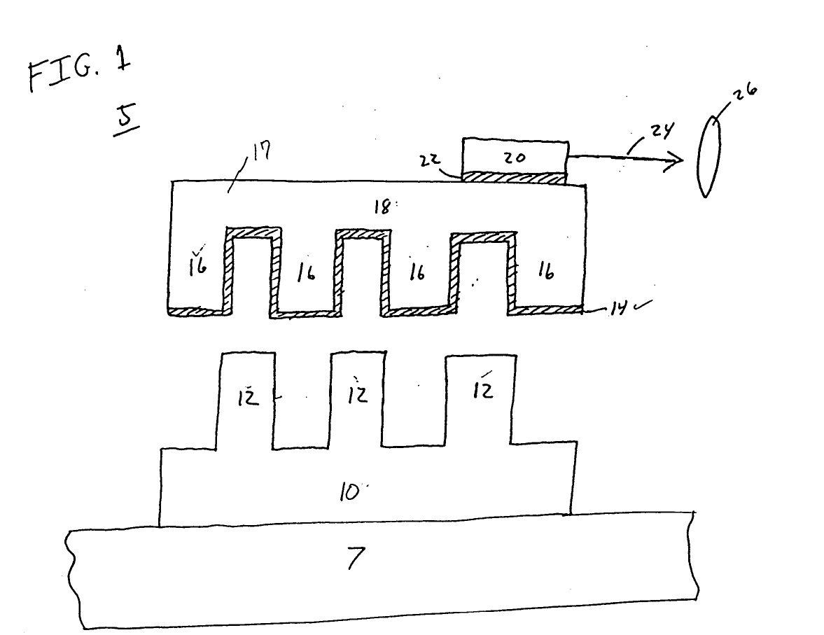

Turning now to FIG. 1, an improved optical component mounting structure 5, in accordance with the present invention, is illustrated. In a preferred embodiment, structure 5 includes a supporting substrate 7 with a mounting comb 10 fixedly attached thereon. Mounting comb 10 includes a plurality of spaced apart, substantially vertical fingers 12 extending upwardly from a substantially horizontal base, the bottom surface of which is fixed to the upper surface of substrate 7. Mounting structure 5 also includes a component receiving comb 18. Comb 18 includes a plurality of substantially vertical fingers 16 that extend downwardly from a lower surface of a base 17. An optoelectronic device 20 is fixedly attached to an upper surface (in this embodiment) of base 17 of comb 18. It will be understood, that in some applications it may be convenient to position optoelectronic device 20 on a different surface or in a different orientation.

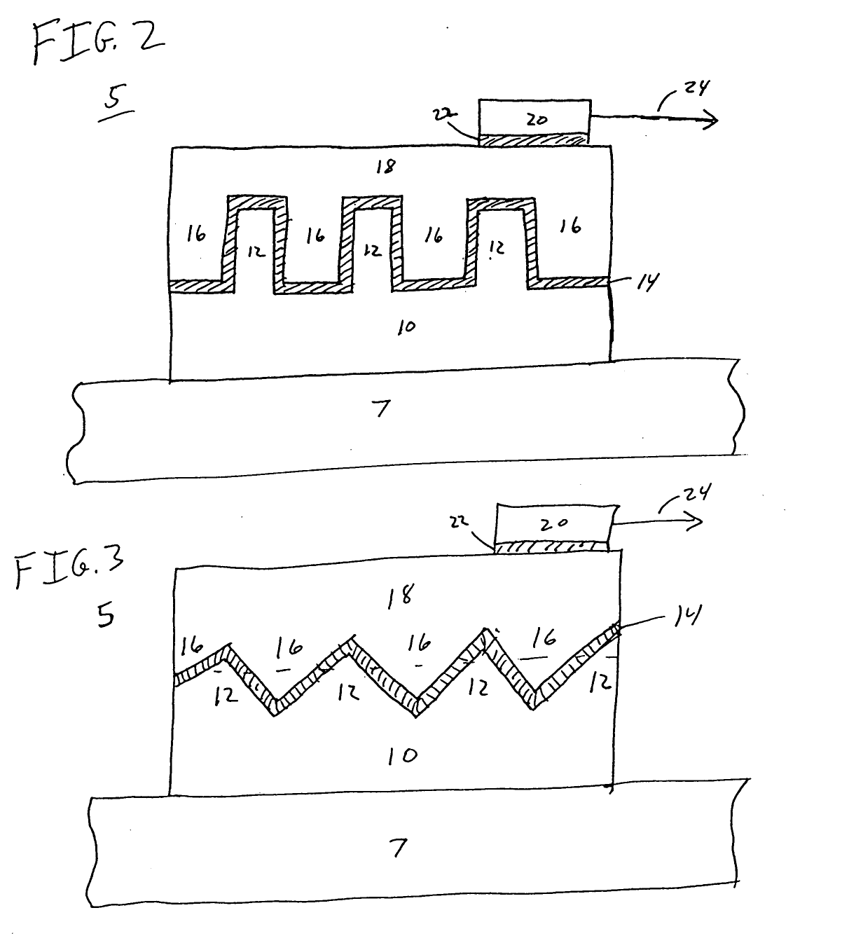

Fingers 12 and 16 are designed to be interdigitated or interlocking, as illustrated in FIG. 2, and are fixedly held together using an adhesive layer 14. In this embodiment, fingers 12 and 16 are rectangular in shape. However, it will be understood that fingers 12 and 16 can have other shapes, such as triangular (See FIG. 3), serrated or rounded. The use of interdigitated combs 10 and 18 provides a number of substantial advantages in mounting structure 5 that will be discussed in more detail below. For example, mounting structure 5 allows for better vertical alignment of optoelectronic device 20.

Adhesive layer 14 can be an epoxy, glue, solder, or a similar material layer with suitable properties for adhesion. In the preferred embodiment, adhesive layer 14 has a thickness which is substantially constant with temperature changes and has, for example, a thickness of approximately 5 μm. However, it is anticipated that the thickness of adhesive layer 14 can be within a range from approximately 3 μm to 10 μm and depends, to some extent, on the thickness of optoelectronic device 20. It will be understood that in some embodiments, adhesive layer 14 can be cured typically using UV light and/or baking at a high temperature. Typical curing temperatures are below 300° C., but the temperature depends on the adhesive and the material to be adhered.

In this embodiment, adhesive layer 14 is positioned on comb 18 as a continuous layer on the surfaces of fingers 16. It will be understood, however, that the positioning of adhesive layer 14 on comb 18 is for illustrative purposes only and layer 14 could be placed initially on comb 10. Also, it will be understood that combs 10 and/or 18 can include a material with a desired property for adhesion to adhesive layer 14, such as a semiconductor (i.e. silicon, etc.), a glass or ceramic, or a conductive material (i.e. gold, copper, etc.). However, preferably the coefficient of thermal expansion of the material included in comb 10 is similar to the coefficient of expansion of the material included in substrate 7 to provide more temperature stable alignment.

In this embodiment, for purposes of explanation, optoelectronic device 20 includes a semiconductor laser such as an edge emitting or surface-emitting laser but it could be another type of light emitting device or a light receiving device, such as a photodiode or the like. Thus, optoelectronic device 20 includes an I/O light port that emits light in some applications (e.g. lasers, etc.) and that receives light in other applications (e.g. photodiodes, etc.). Optoelectronic device 20 is fixedly attached to comb 18 using an adhesive layer 22. Adhesive layer 22 can include an epoxy, glue, solder, or a similar material layer with suitable properties for adhesion. Optoelectronic device 20 is positioned such that emitted light 24 is directed to an optical system 26 without interference from comb 18. While optical system 26 is illustrated as a single lens for simplicity, it will be understood that it can be, for example, an optical fiber, photodetector, optical lens or lenses, polarizer, or a similar optical component or components designed to interact with light 24. Also, optical system 26 is mounted adjacent substrate 7 and generally will be fixed relative to (or on) substrate 7. Thus, optical system 26 includes an I/O light port that emits light to optoelectronic device 20 in some applications and that receives light from Optoelectronic device 20 in other applications.

By fixedly interlocking fingers 12 and 16 with adhesive layer 14 therebetween, any vertical movement between optoelectronic device 20 and optical system 26 is substantially reduced with variations in temperature. Also, the optical alignment between optoelectronic device 20 and optical system 26 can be optimized through the choice of thickness for combs 10 and 18. For example, the thickness of combs 10 and 18 can be chosen to compensate for variations in a thickness of optoelectronic device 20.

For example, optoelectronic devices, such as semiconductor lasers, typically have thickness variations from ±10 μm. A single mode optical fiber included in optical system 26 will typically have a core diameter in a range from approximately 8 μm to 10 μm. Consequently, there is a good chance that the semiconductor laser will be vertically misaligned with the single mode optical fiber. It will also be understood by those skilled in the art that a relatively substantial amount of vertical adjustment can be achieved by varying the amount of adhesive material used in layer 14. As a typical example, by including more adhesive in layer 14 optoelectronic device 20 can be positioned initially slightly above optical alignment with optical system 26. During assembly and before the adhesive is cured, a slight downward pressure can be placed on the upper surface of base 17 of comb 18 forcing some of the adhesive either out or into a reoriented configuration so that optoelectronic device 20 is brought into substantially perfect vertical alignment with optical system 26. The adhesive is then cured or allowed to cure in this position. The thickness of layer 14 (e.g. the amount of adhesive between the ends of the teeth and the mating trenches) can be used, for example, to compensate for any manufacturing tolerances in the overall subassembly or in mounting structure 5.

Thus, combs 10 and 18 provide reliable and stable optical alignment over large ranges of temperature variations. Also, combs 10 and 18 can be combined to set the positioning of optoelectronic device 20 relative to optical system 26 to achieve optimum optical alignment without the need for additional labor or components. Thus, new and improved mounting structure for optical components or subassemblies in optoelectronic modules is disclosed. The new and improved optical component mounting structure can be easily incorporated into any of the present optoelectric modules and provides greater flexibility in the mounting of components and less sensitivity to temperature variations. Also, the new and improved optical component mounting structure provides greater reliability and optical alignment throughout temperature variations and is rugged and stable so that optical alignment is not disturbed by use or temperature changes.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A mounting structure in optical subassemblies comprising:
an optical system with an I/O light port;
a supporting substrate positioned adjacent the optical system;
an optoelectronic device with an I/O light port;
a mounting comb with a plurality of spaced apart fingers fixedly mounted on the substrate;
a receiving comb with a plurality of spaced apart fingers having the optoelectronic device fixedly mounted thereon; and
the fingers of the receiving comb being fixed in an interdigitated orientation with the fingers of the mounting comb by a layer of adhesive positioned therebetween so that the I/O light port of the optoelectronic device is optically aligned with the I/O light port of the optical system.

2. A mounting structure in optical subassemblies as claimed in claim 1 wherein the optoelectronic device is one of a light emitting device and a light receiving device.

3. A mounting structure in optical subassemblies as claimed in claim 2 wherein the light emitting device is one of an edge emitting laser and a surface-emitting laser.

4. A mounting structure in optical subassemblies as claimed in claim 2 wherein the light receiving device is a photodiode.

5. A mounting structure in optical subassemblies as claimed in claim 1 wherein the optical system includes an optical fiber.

6. A mounting structure in optical subassemblies as claimed in claim 1 wherein the adhesive positioned between the interdigitated fingers includes one of epoxy, glue, and solder.

7. A mounting structure in optical subassemblies comprising:
an optical system with an I/O light port;
a supporting substrate positioned adjacent the optical system;
an optoelectronic device with an I/O light port;
a mounting comb including a base with a mounting surface and a plurality of spaced apart fingers extending from the base perpendicular to and opposite the mounting surface of the mounting comb, the mounting surface of the mounting comb being fixedly attached to a surface of the substrate with the plurality of spaced apart fingers of the mounting comb extending outwardly from the substrate;
a receiving comb including a base with a mounting surface and a plurality of spaced apart fingers extending from the base perpendicular to and opposite the mounting surface of the receiving comb, the optoelectronic device being fixedly mounted on the mounting surface of the receiving comb; and
the fingers of the receiving comb being fixed in an interdigitated orientation with the fingers of the mounting comb by a layer of adhesive positioned therebetween so that the optoelectronic device is spaced from the substrate and the I/O light port of the optoelectronic device is optically aligned with the I/O light port of the optical system.

8. A mounting structure in optical subassemblies as claimed in claim 7 wherein the optoelectronic device is one of a light emitting device and a light receiving device.

9. A mounting structure in optical subassemblies as claimed in claim 8 wherein the light emitting device is one of an edge emitting laser and a surface-emitting laser.

10. A mounting structure in optical subassemblies as claimed in claim 8 wherein the light receiving device is a photodiode.

11. A mounting structure in optical subassemblies as claimed in claim 7 wherein the optical system includes an optical fiber.

12. A mounting structure in optical subassemblies as claimed in claim 7 wherein the adhesive positioned between the interdigitated fingers includes one of epoxy, glue, and solder.

13. A method of mounting and optically aligning an optical device with an optical system in an optical subassembly, comprising the steps of:
providing an optical system with an I/O light port, a supporting substrate positioned adjacent the optical system, an optoelectronic device with an I/O light port, a mounting comb including a base with a mounting surface and a plurality of spaced apart fingers extending from the base perpendicular to and opposite the mounting surface of the mounting comb, and a receiving comb including a base with a mounting surface and a plurality of spaced apart fingers extending from the base perpendicular to and opposite the mounting surface of the receiving comb;
fixedly attaching the mounting surface of the mounting comb to a surface of the substrate with the plurality of spaced apart fingers of the mounting comb extending outwardly from the substrate;
fixedly mounting the optoelectronic device on the mounting surface of the receiving comb;
applying a layer of adhesive to one of surfaces of the plurality of fingers of the receiving comb and the plurality of fingers of the mounting comb; and
placing the fingers of the receiving comb in an interdigitated orientation with the fingers of the mounting comb so that the optoelectronic device is spaced from the substrate and the I/O light port of the optoelectronic device is optically aligned with the I/O light port of the optical system.

14. A method as claimed in claim 13 wherein the step of applying the layer of adhesive includes applying a layer with a thickness in a range of approximately 3 μm to 10 μm.

15. A method as claimed in claim 13 wherein the step of applying the layer of adhesive includes applying a layer of adhesive with a thickness sufficient to misalign the I/O light port of the optoelectronic device and the I/O light port of the optical system and further includes applying pressure to the receiving comb sufficient to bring the I/O light port of the optoelectronic device into optical alignment with the I/O light port of the optical system.
